(19) United States
(12) Patent Application Publication
(10) Pub. No.: US 2014/0129297 A1
(43) Pub. Date: May 8, 2014

(54) DETERMINING CALCULATION EXPRESSION FOR FINDING KPI RELATING TO BUSINESS PROCESS

(71) Applicant: International Business Machines Corporation, Armonk, NY (US)

(72) Inventors: Futoshi Iwama, Tokyo (JP); Kohichi Kamijoh, Tokyo (JP); Yasuharu Katsuno, Tokyo (JP); Yuhichi Nakamura, Tokyo (JP); Shiho Negishi, Tokyo (JP)

(73) Assignee: International Business Machines Corporation, Armonk, NY (US)

(21) Appl. No.: 14/065,627

(22) Filed: Oct. 29, 2013

(30) Foreign Application Priority Data
Nov. 7, 2012 (JP) 2012-245695

(51) Int. Cl. G06Q 10/06

(52) U.S. Cl. CPC G06Q 10/06393
USPC 705/7.39

(57) ABSTRACT

A computer-implemented method is disclosed for determining a calculation expression for finding a KPI relating to a business process (process KPI) on the basis of a KPI obtained in each task (task KPI), the business process being representable as a graph structure including a plurality of tasks and edges representing how processing of the tasks proceeds. The method includes preparing a table defining a group of composite operation expressions for the task KPIs of the plurality of tasks, the composite operation expressions being associated with a predetermined relation of the plurality of tasks for each task KPI type; determining composite operation expressions for the task KPIs over the business process for each task KPI type by referring to the table; and creating a calculation expression for finding the process KPI of the business process using the composite operation expressions for the task KPIs over the business process.

### PRIORITY

This application claims priority to Japanese Patent Application No. 2012-245695, filed Nov. 7, 2012, and all the benefits accruing therefrom under 35 U.S.C. §119, the contents of which in its entirety are herein incorporated by reference.

### BACKGROUND

The present invention generally relates to information processing techniques, and more specifically, it relates to a computer-implemented method, a program, and a system for determining a calculation expression for finding a KPI relating to a business process.

In recent years, in conducting business activities by corporations, an information system for processing their business processes has become increasingly important. With this, it is necessary for a user of such an information system to grasp business values such as earnings and sales, in addition to values in an aspect of the information processing technology such as the performance and availability of the system. For IT service providers, showing business values such as earnings and sales in suggesting actions or the like appropriately and timely is a key to the business success.

To grasp such business values in such a business process processing system, a key performance indicator (also referred to simply as “KPI” in the present specification) is defined and is often used. Exemplary background references discussing KPI are listed below.
Japanese Unexamined Patent Application Publication No. 2009-217594
Japanese Unexamined Patent Application Publication No. 2006-189960
Japanese Unexamined Patent Application Publication No. 2007-179477
Japanese Unexamined Patent Application Publication No. 2008-299646
Japanese Unexamined Patent Application Publication No. 2009-230419
Japanese Unexamined Patent Application Publication No. 2012-89113

### SUMMARY

In one embodiment, a computer-implemented method is disclosed for determining a calculation expression for finding a KPI relating to a business process (process KPI) on the basis of a KPI obtained in each task (task KPI), the business process being representable as a graph structure including a plurality of tasks and edges representing how processing of the tasks proceeds. The method includes preparing a table defining a group of composite operation expressions for the task KPIs of the plurality of tasks, the composite operation expressions being associated with a predetermined relation of the plurality of tasks for each task KPI type; determining composite operation expressions for the task KPIs over the business process for each task KPI type by referring to the table; and creating a calculation expression for finding the process KPI of the business process using the composite operation expressions for the task KPIs over the business process.

In another embodiment, system is disclosed for determining a calculation expression for finding a KPI relating to an entire business process (process KPI) on the basis of a KPI obtained in each task (task KPI), the business process being representable as a graph structure including a plurality of tasks and edges representing how processing of the tasks proceeds. The system includes a table defining a group of composite operation expressions for the task KPIs of the plurality of tasks, the composite operation expressions being associated with a predetermined relation of the plurality of tasks for each task KPI type; a determining unit configured to determine composite operation expressions for the task KPIs over the business process for each task KPI type by referring to the table; and a creating unit configured to create a calculation expression for finding the process KPI of the business process using the composite operation expressions for the task KPIs over the business process.

### BRIEF DESCRIPTION OF THE SEVERAL VIEWS OF THE DRAWINGS

FIG. 1 is a functional block diagram of a KPI calculation system according to an embodiment of the present invention.

FIG. 2 is a flowchart that illustrates a whole operation in the KPI calculation system according to an embodiment of the present invention.

FIG. 3 is a flowchart that illustrates a specified operation for determining a KPI calculation expression in the KPI calculation system according to an embodiment of the present invention.

FIGS. 4(a), 4(b) and 4(c) include illustrations for describing relations between two tasks in a business process according to an embodiment of the present invention.

FIG. 5 is an illustration for describing an example of a KPI classification table according to an embodiment of the present invention.

FIG. 6 is an illustration for describing an example of a KPI conversion table according to an embodiment of the present invention.

FIG. 7 is an illustration for describing an example of a business process definition according to an embodiment of the present invention.

FIG. 8 is an illustration for describing the example of the business process definition according to an embodiment of the present invention.

FIGS. 9(a), 9(b), 9(c) and 9(d) include illustrations for describing transformation of a graph structure to rewrite a business process definition to parallel standard form according to an embodiment of the present invention.

FIGS. 10(a), 10(b), 10(c) and 10(d) include illustrations for describing transformation of a graph structure to rewrite a business process definition to parallel standard form according to an embodiment of the present invention.

FIG. 11 is an illustration for describing a technique for determining a maximum time necessary to execute a business process according to an embodiment of the present invention.

FIG. 12 is an illustration for describing a technique for determining a cost of a business process according to an embodiment of the present invention.

FIG. 13 illustrates an example of a KPI tree in a business process level according to an embodiment of the present invention.

FIG. 14 illustrates an example of a KPI tree broken down to a task KPI level according to an embodiment of the present invention.

FIG. 15 illustrates an example of a hardware configuration of an information processing apparatus suitable for achieving the KPI calculation system according to an embodiment of the present invention.

### DETAILED DESCRIPTION

In defining a plurality of KPIs relating to a business process, a KPI tree that represents influences and a relation of the plurality of KPIs is typically generated. In particular, if a calculation expression for finding a KPI relating to a business process (also referred to as “process KPI” in the present specification) can be defined from a KPI obtained in each of tasks contained in the business process (also referred to as “task KPI” in the present specification) in a KPI tree, it can bring an advantage, for example, timely gaining information leading to a strategic target of an organization from achievements of daily operations of the organization. However, it is not easy to define such a calculation expression, and a technique for automatically creating a standard established calculation expression does not exist yet. Currently, an expert at a concerned business domain produces a KPI tree containing such a calculation expression on the basis of their experiences.

Accordingly embodiments of the present invention provide a computer-implemented method, a program, and a system for determining a calculation expression for finding a KPI relating to an entire business process.

To achieve the above, a computer-implemented method for determining a calculation expression for finding a KPI relating to an entire business process (“process KPI”) is provided. The business process includes a plurality of tasks and edges representing how processing of the tasks proceeds. The process KPI is found on the basis of a KPI obtained in each task (“task KPI”) included in the business process. The method includes the steps of preparing a table defining a group of composite operation expressions for the task KPIs of the plurality of tasks, the composite operation expressions being associated with a predetermined relation of the plurality of tasks for each task KPI type, determining composite operation expressions for the task KPIs over the business process for each task KPI type by referring to the table, and creating a calculation expression for finding the process KPI of the business process using the composite operation expressions for the task KPIs over the business process.

A set of possible values for the task KPI may be a semi-ring. The determining may include the steps of identifying a predetermined rewriting scheme for the graph structure with respect to the group of composite operation expressions corresponding to the task KPIs for the type of a certain task KPI, the rewriting scheme defining a scheme for converting a graph structure including a portion being impossible to be subjected to composite operation using the group of composite operation expressions into a graph structure including such a portion, rewriting the graph structure of the business process using the identified rewriting scheme, and determining the composite operation expressions for the task KPIs over the business process for the type of the certain task KPI by referring to the table.

Preferably, the rewriting scheme may include a scheme for rewriting the graph structure of a given business process to parallel standard form. More preferably, the scheme for rewriting the graph structure of the given business process to parallel standard form may be implemented by repeating rewriting of the graph structure using at least one of the following calculation expressions:

(P∥Q);R→(P;R)∥(Q;R)

R;(P∥Q)→(R;P)∥(R;Q)

R∥(P∥Q)→(R∥P∥Q)

P∥Q→Q∥P

where P, Q, and R indicate tasks contained in the given business process.

The rewriting scheme may include a scheme for rewriting the graph structure of a given business process to sequential standard form. More specifically, the scheme for rewriting the graph structure of the given business process to sequential standard form may be implemented by repeating rewriting of the graph structure using at least one of the following calculation expressions:

(P;Q)∥R→(P∥R);(Q∥R)

R∥(P;Q)→(R∥P);(R∥Q)

R∥(P∥Q)→(R∥P∥Q)

P∥Q→Q∥P

where P, Q, and R indicate tasks contained in the given business process.

The predetermined relation of the plurality of tasks may include at least one of parallel composition, sequential composition, and branch.

The method may further include determining the calculation expression for determining the process KPI using a conversion function between provided task KPIs. More preferably, the conversion function may be a time-dependent function.

The method may further include prompting for entry of a conversion function to be defined, in response to detection of presence of the conversion function to be defined.

The method may further include receiving a business process definition including a plurality of tasks and edges representing how processing of the tasks proceeds. The method may further include identifying a type of a task KPI necessary to find the process KPI of the business process.

One embodiment of the present invention described above is a computer-implemented method for determining a calculation expression for finding a process KPI. Embodiments of the present invention can also be implemented as a program, a program product, software, a software product, a system, an apparatus, and the like.

A program product or a software product can include a storage medium that stores the above-described program or software or a medium for transmitting the program or software. The program can cause a computer to perform the steps included in the above-described method.

The above-described summary does not list all of the characteristics necessary in the present invention, and it is to be noted that combinations and sub-combinations of the components can comprise embodiments the invention.

An embodiment for carrying out the present invention will be further illustrated below with reference to the drawings. The embodiment described below does not limit the invention described in the claims. It is to be noted that not all of combinations of characteristics described in an embodiment are necessarily required for the solution of the invention.

The present invention can be carried out in many different forms and should not be construed to be limited to the content of the description of the embodiment. Basically, the same reference numerals are used in the same elements throughout the description of the embodiment.

An embodiment of the present invention presents a calculation expression for a KPI relating to a provided business process (also referred to as “process KPI” in the present specification) through information processing in a KPI calculation system. In an embodiment of the present invention, a business process definition that is a target for presenting a calculation expression for a KPI is provided as a graph structure that contains a plurality of tasks and edges representing how the processing of the tasks proceeds.

In an embodiment of the present invention, a calculation expression for finding a process KPI is determined on the basis of a KPI defined for each task contained in a business process definition and obtained in each task (also referred to as “task KPI” in the present specification), and the calculation expression is shown to a user. In an embodiment of the present invention, a set of possible values for the task KPI is a semi-ring.

The KPI calculation system according to an embodiment of the present invention contains a KPI classification table. The KPI classification table is a table for, when a plurality of tasks are in a predetermined relation, defining a composite operation for composing their task KPIs. The predetermined relation between the plurality of tasks in an embodiment of the present invention includes at least one of “sequential composition,” “parallel composition,” and “branch.”

In an embodiment of the present invention, when a business process definition is provided, a type of a task KPI necessary to find a calculation expression for finding its process KPI is defined. Then task KPIs defined for each task are composed by referring to the KPI classification table for each identified task KPI type. Then the calculation expression for finding the process KPI is determined using the composed task KPI.

In an embodiment of the present invention, when it is necessary to convert a task KPI into another task KPI in the calculation expression for finding a process KPI, a KPI conversion table is referred to. The KPI conversion table defines KPI conversion functions for conversion between different KPIs. A task KPI is converted using its corresponding conversion function in the KPI conversion table. If a necessary conversion function is not defined in the KPI conversion table, the KPI calculation system in an embodiment of the present invention prompts a user to define the conversion function.

In an embodiment of the present invention, when a given business process definition is a structure that includes a plurality of tasks being in a relation that is none of provided structures of “sequential composition,” “parallel composition,” and “branch,” if no action is taken, task KPIs cannot be composed. In an embodiment of the present invention, the KPI classification table includes a definition of a scheme for rewriting a graph structure to eliminate such a structure.

In an embodiment of the present invention, when a structure that cannot be converted into a business process definition exists, the graph structure is rewritten in accordance with the KPI classification table for each task KPI type. In an embodiment of the present invention, a relation between a plurality of tasks included in the rewritten graph structure corresponds to “sequential composition,” “parallel composition,” or “branch.” Then the KPI calculation system determines a calculation expression for finding a process KPI in accordance with the KPI classification table.

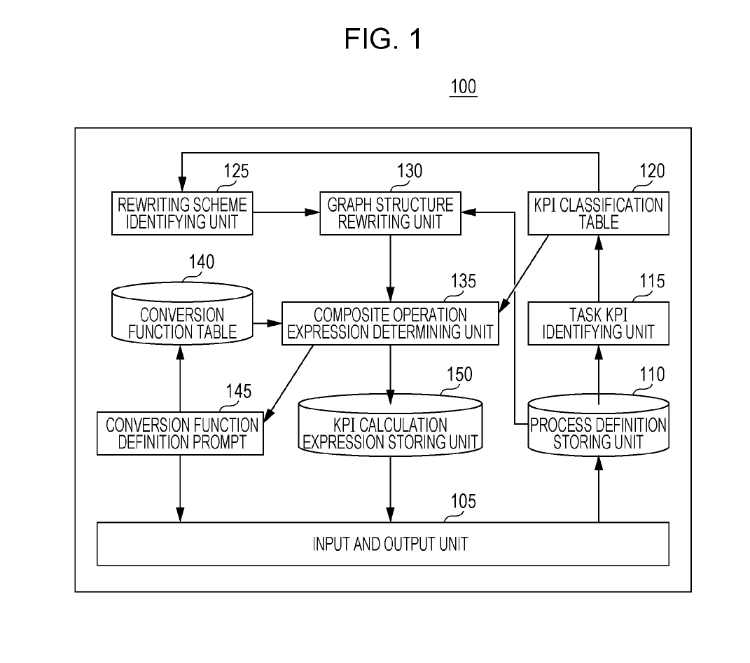

An embodiment of present invention is now described in detail below with reference to FIGS. 1 to 15.

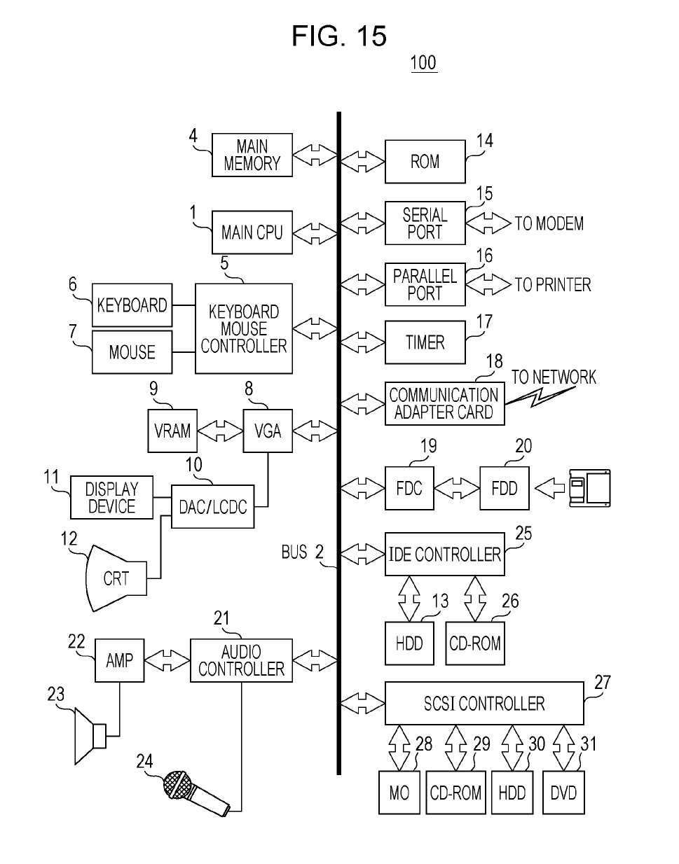

FIG. 1 is a functional block diagram of a KPI calculation system 100 according to an embodiment of the present invention. The elements illustrated in the functional block diagram of FIG. 1 can be achieved by, in an information processing apparatus including a hardware configuration illustrated in FIG. 15, loading a computer program, such as an operating system and an application program, stored in a hard disk device 13 and the like on a main memory 4, causing a main CPU 1 to read it, causing a hardware resource and a software resource to cooperate with each other.

The KPI calculation system 100 according to an embodiment of the present invention includes an input and output unit 105, a process definition storing unit 110, a task KPI identifying unit 115, a KPI classification table 120, a rewriting scheme identifying unit 125, a graph structure rewriting unit 130, a composite operation expression determining unit 135, a conversion function table 140, a conversion function defining prompt 145, and a KPI calculation expression storing unit 150.

The input and output unit 105 provides a user and/or another computer system with an input and output interface of the KPI calculation system 100. In an embodiment of the present invention, for example, the user enters a definition of a business process that is a target for determining a KPI calculation expression through the input and output unit 105. The business process entered here is stored in the process definition storing unit 110. The conversion function defining prompt 145 prompts the user to enter a definition of a conversion function through the input and output unit 105. In an embodiment of the present invention, the calculation expression for the process KPI finally determined and stored in the KPI calculation expression storing unit 150 is shown to the user through the input and output unit 105.

The KPI calculation system 100 according to an embodiment of the present invention further includes the process definition storing unit 110. The process definition storing unit 110 stores a definition of a business process that is a target for determining a calculation expression for finding a process KPI. The business process definition in an embodiment of the present invention is a graph structure that includes nodes and edges. The nodes correspond to a plurality of tasks. The edges connect the nodes and represent how the processing of the tasks proceeds.

The business process definition can take various forms. Examples thereof can include standard formats that support a business process execution language (BPEL) and a business process modeling notation (BPMN), a unique format of proprietary software, and combinations thereof.

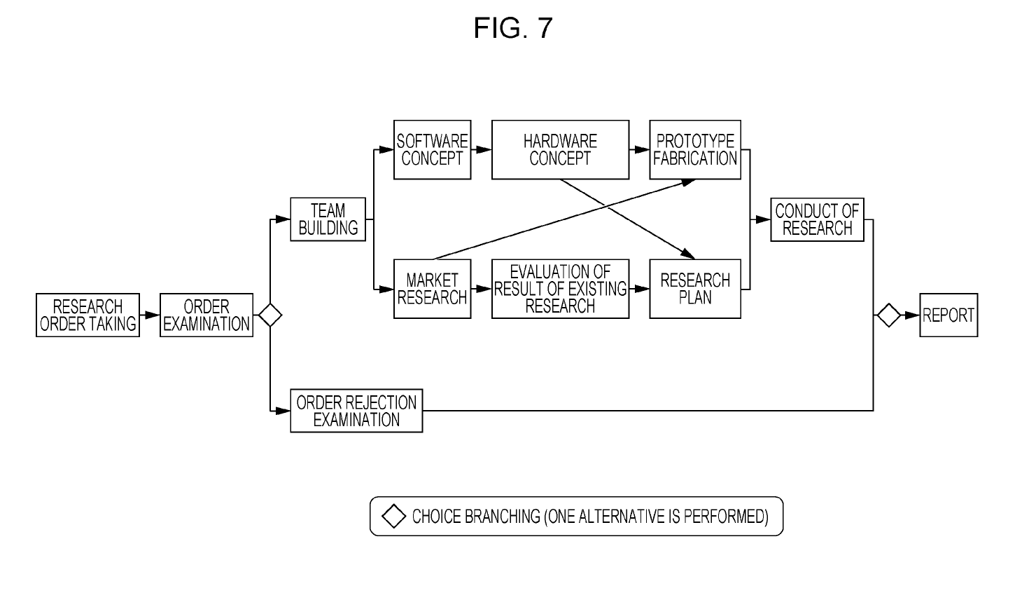

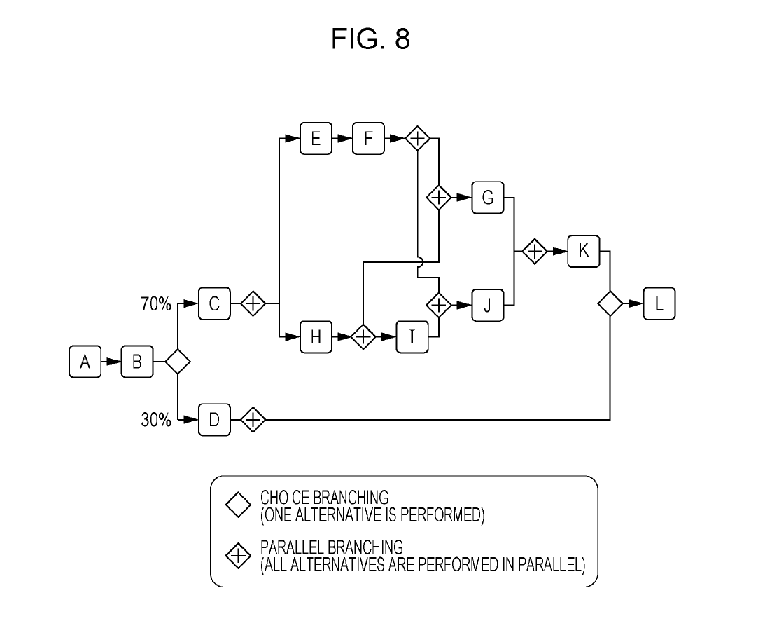

Next, one example of a business process definition stored in the process definition storing unit 110 is further described using FIGS. 7 and 8.

FIG. 7 is an illustration for describing an example of a business process according to an embodiment of the present invention. The business process definition according to an embodiment of the present invention can be represented as a graph structure that includes nodes corresponding to a plurality of tasks and edges connecting the nodes and representing how the processing of the tasks proceeds. The content of this example of the business process is a process for taking and reporting a research order.

In the example of the business process illustrated in FIG. 7, the process begins with a “research order taking” task and then performs an “order examination” task. Subsequently, either one of two tasks of “team building” and “order rejection examination” is performed. The process can proceed from the “team building” task to “software concept” and “market research” tasks. The process can proceed from the “software concept” task to a “hardware concept” task and then can proceed to a “prototype fabrication” task and a “research plan” task. The process can proceed from the “market research” task to the “prototype fabrication” task and an “evaluation of result of existing research” task. The process can proceed from the “evaluation of result of existing research” task to the “research plan” task.

For further description, in this example of the business process, the process joins from the two tasks of “prototype fabrication” and “research plan” to a “conduct of research” task. The process proceeds from the “conduct of research” or “order rejection examination” task to a “report” task. Then the example of the business process illustrated in FIG. 7 ends.

FIG. 8 is an illustration for describing the example of the business process illustrated in FIG. 7. In an embodiment of the present invention, the process definition storing unit 110 stores the network structure illustrated in FIG. 8 as the business process definition. It is to be noted that the “research order taking,” “order examination,” “team building,” “order rejection examination,” “software concept,” “hardware concept,” “prototype fabrication,” “market research,” “evaluation of result of research,” “research plan,” “conduct of plan,” and “report” tasks correspond to nodes A, B, C, D, E, F, G, H, I, J, K, and L illustrated in FIG. 8, respectively.

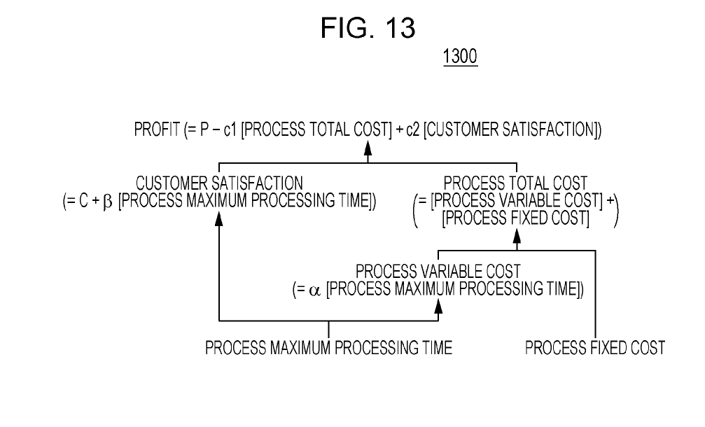

The business process definition according to an embodiment of the present invention further includes a KPI tree in the process level. FIG. 13 illustrates an example of such a KPI tree in the process level. The top indicator in this KPI tree is a profit P. The profit P is calculated on the basis of a customer satisfaction (CS) and a process total cost. The customer satisfaction is calculated on the basis of a process maximum processing time. The process total cost is calculated on the basis of a process variable cost and a process fixed cost. The process variable cost is calculated on the basis of the process maximum processing time.

The process maximum processing time and the process fixed cost are calculated on the basis of their respective task KPIs, but the calculation expression used in the calculation is not obvious. It is to be noted that such a calculation expression is automatically determined by the KPI calculation system according to an embodiment of the present invention referring to the business process definition, KPI classification table 120, conversion function table 140, and the like.

Referring back to the description of FIG. 1, the task KPI identifying unit 115 in an embodiment of the present invention reads a business process definition stored in the process definition storing unit 110 and identifies the type of the task KPI necessary for the KPI calculation expression for finding the process KPI corresponding to that business process definition.

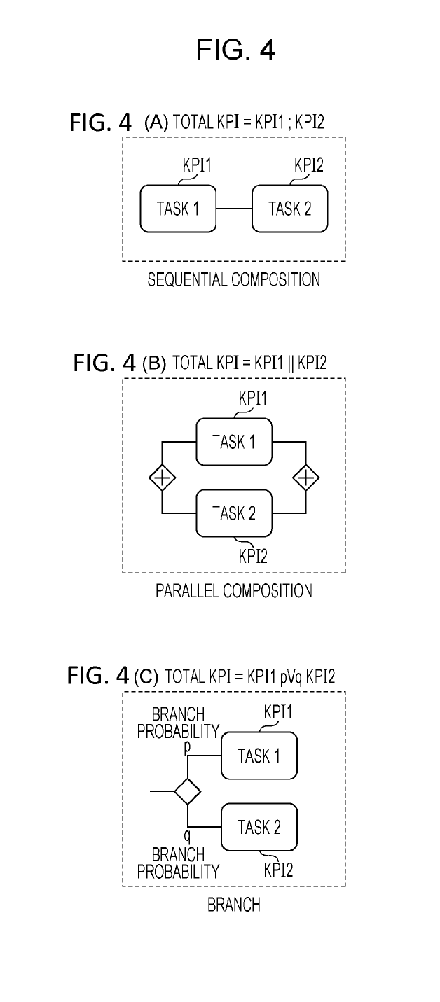

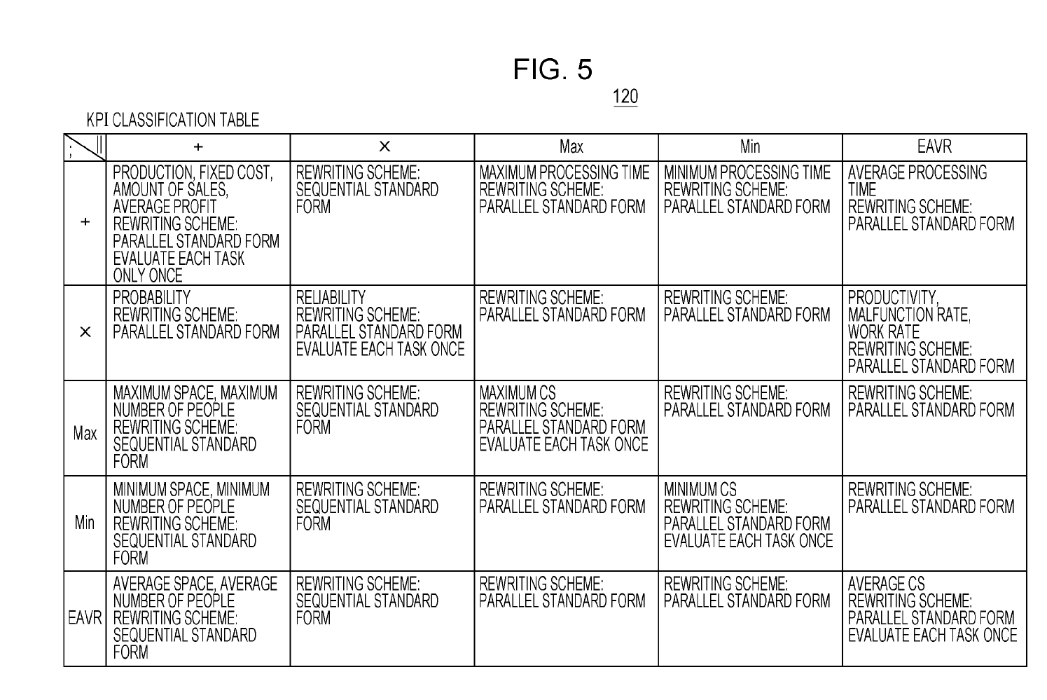

The KPI classification table 120 in an embodiment of the present invention is a table that defines a group of composite operation expressions for task KPIs of a plurality of tasks, the composite operation expressions being associated with a predetermined relation of the plurality of tasks for each task KPI type. The KPI classification table 120 in an embodiment of the present invention is further described below using FIGS. 4 and 5.

FIG. 4 includes illustrations for describing predetermined relations of a plurality of tasks in a business process according to an embodiment of the present invention. Before the KPI classification table 120 in an embodiment of the present invention is described, the predetermined relations of a plurality of tasks in a business process according to an embodiment of the present invention are described using FIG. 4.

In an embodiment of the present invention, the predetermined relations of a plurality of tasks include “sequential composition,” “parallel composition,” and “branch.” Examples of these relations of connection are illustrated in (A), (B), and (C) in FIG. 4, respectively. The example illustrated in FIG. 4 is an example of a relation of connection between two tasks. An actual business process may have a relation of connection of three or more tasks.

In an embodiment of the present invention, the task KPI composite operation of tasks in sequential composition is represented as “KPI1;KPI2,” the task KPI composite operation of tasks in parallel composition is represented as “KPHI1∥KPI2.” The task KPI composite operation of tasks in branch with branch probabilities p and q is represented as “KPI1pVqKPI2.”

FIG. 5 is an illustration for describing an example of the KPI classification table 120 according to an embodiment of the present invention. The uppermost row in the KPI classification table 120 indicates how a composite operation value is determined for each of the task KPI types of a plurality of tasks when the tasks are in parallel composition (mark: “∥”). The leftmost column in the KPI classification table 120 indicates how a composite operation value is determined for each of the task KPI types of a plurality of tasks when the tasks are in sequential composition (mark: “;”). In the KPI classification table 120 illustrated in FIG. 5, how a composite operation value is determined is represented as “+,” “×,” “Max,” “Min,” and “EAVR.” Combinations of two composite operations defined for the parallel composition (mark: “∥”) and sequential composition (mark: “;”) for each task KPI in the KPI classification table 120 in an embodiment of the present invention may be any combinations in which a set of possible values for that task KPI is a semi-ring under the combinations of the two composite operations. Accordingly, the types of the composite operations defined in the KPI classification table 120 are not limited to “+,” “×,” “Max,” “Min,” and “EAVR,” and it is to be noted that a person skilled in the art can extend the KPI classification table 120 if needed by incorporating a composite operation having such a feature.

The mark “+” indicates that, for the KPI type, the composite operation value of a plurality of tasks that are a target of a composite operation is the sum of the task KPIs of the plurality of tasks, and the mark “×” indicates that the composite operation value of a plurality of tasks is the product of the task KPIs. “Max” indicates that the composite operation value of a plurality of tasks is the maximum value of the task KPIs of the plurality of tasks, and “Min” indicates that the composite operation value of a plurality of tasks is the minimum value of the task KPIs of the plurality of tasks. “EAVR” indicates that the composite operation value of a plurality of tasks is an extended average value, that is, the average value of the task KPIs of a plurality of tasks to be composed.

For example, in the case of a task KPI “product,” if a plurality of tasks are in parallel composition, an add operation (“+”) of task KPIs of both tasks is performed; if a plurality of tasks are in sequential composition, an add operation (“+”) of task KPIs of both tasks is also performed. For another example, in the case of a task KPI “maximum space,” if a plurality of tasks are in parallel composition, an add operation (“+”) of task KPIs of both tasks is performed; if a plurality of tasks are in sequential composition, the maximum value (“Max”) of the task KPIs of the plurality of tasks is the composite operation value. Because a person skilled in the art would be able to understand a technique for composite operations for other types of task KPIs by reading the above description and seeing the KPI classification table 120 illustrated in FIG. 5, the composite operations for other types of task KPIs are not descried here.

The KPI classification table (120) includes a definition of a scheme for converting the graph structure to determine a composite operation expression for a task KPI for each task KPI type when a given business process definition has a structure that includes a plurality of tasks being in a relation that is none of provided structures, “sequential composition,” “parallel composition,” and “branch.”

The rewriting schemes in an embodiment of the present invention include three kinds: (1) “rewriting to parallel standard form,” (2) “rewriting to sequential standard form,” and (3) “rewriting to parallel standard form and evaluating each task only once.”

(1) The “rewriting to parallel standard form” is a scheme of rewriting the graph structure of a business process to a graph structure that is referred to as “parallel standard form” in the present specification and that can be represented as the following expression.

(P1;P2; . . . ;Pn)∥ . . . ∥(Q1;Q2; . . . ;Qm)

where P1 to Pn and Q1 to Qm indicate tasks contained in a business process.

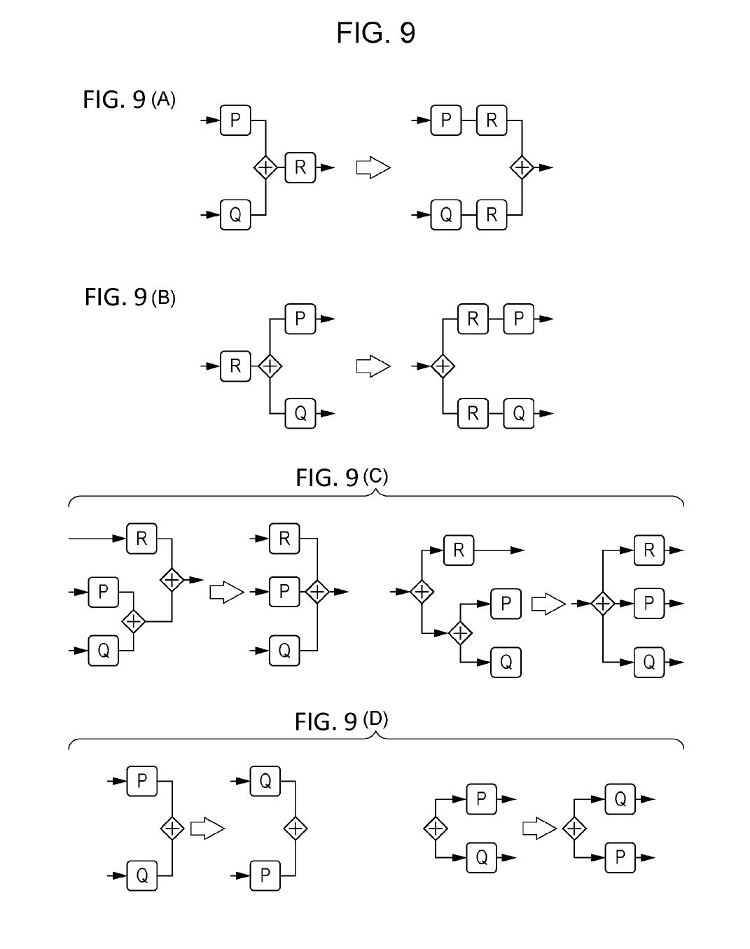

The rewriting to parallel standard form is carried out by repeating rewriting of the graph structure using at least one of the conversion expressions below. That is, when the graph structure rewriting unit 130, which is described below, discovers a section that coincides with the left-hand side of any of the conversion expressions in a graph structure, it rewrites that section to the structure in the right-hand side and repeats this processing until there is no match with the left-hand side of any of the conversion expressions, thereby achieving the rewriting. FIG. 9 illustrates how the graph structure is rewritten in this case. Because a person skilled in the art can carry out operations such as matching of a graph structure and rewriting as appropriate, no further description is provided here.

(P∥Q);R→(P;R)∥(Q;R)

R;(P∥Q)→(R;P)∥(R;Q)

R∥(P∥Q)→(R∥P∥Q)

P∥Q→Q∥P

where P, Q, and R indicate tasks contained in a business process.

(2) The “rewriting to sequential standard form” is a scheme of rewriting the graph structure of a business process to a graph structure that is referred to as “sequential standard form” in the present specification represented as the following expression.

(P1∥P2∥ . . . ∥Pn); . . . ;(Q1∥Q2∥ . . . ∥Qm)

where P1 to Pn and Q1 to Qm indicate tasks contained in a business process.

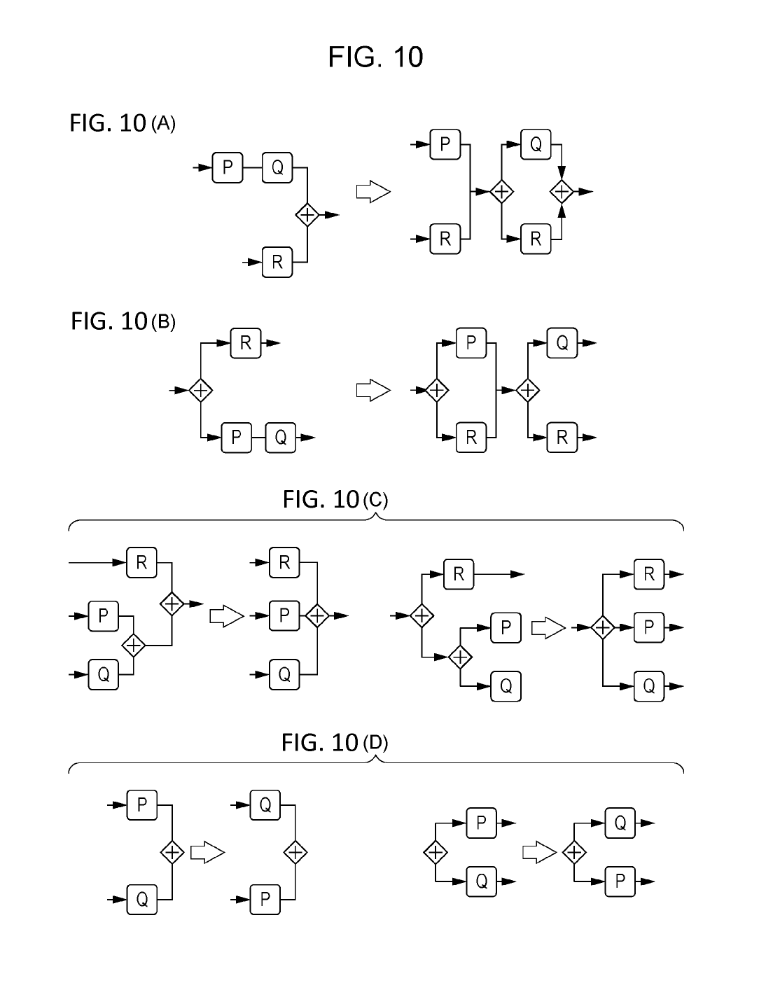

The rewriting to sequential standard form is carried out by repeating rewriting of the graph structure using at least one of the conversion expressions below. That is, when the graph structure rewriting unit 130, which is described below, discovers a section that coincides with the left-hand side of any of the conversion expressions in a graph structure, it rewrites that section to the structure in the right-hand side and repeats this processing until there is no match with the left-hand side of any of the conversion expressions, thereby achieving the rewriting. FIG. 10 illustrates how the graph structure is rewritten in this case. Because a person skilled in the art can carry out operations such as matching of a graph structure and rewriting as appropriate, no further description is provided here.

(P;Q)∥R→(P∥R);(Q∥R)

R∥(P;Q)→(R∥P);(R∥Q)

R∥(P∥Q)→(R∥P∥Q)

P∥Q→Q∥P

where P, Q, and R indicate tasks contained in a business process.

In an embodiment of the present invention, (3) the “rewriting to parallel standard form and evaluating each task only once” rewrites the graph structure using, in addition to the conversion expressions for rewriting to parallel standard form, the following conversion expression:

P∥Q∥P→P∥Q

where P and Q indicate tasks contained in a business process.

Although not used in an embodiment of the present invention, a scheme of “rewriting to sequential standard form and evaluating each task only once” may be used. In this case, the graph structure may be rewritten using, in addition to the conversion expressions for rewriting to sequential standard form, the following conversion expression.

P;Q;P→P

where P and Q indicate tasks contained in a business process.

It is to be noted that, even when the operations of the above-described expressions for the rewriting to parallel standard form and the operations of the above-described expressions for the rewriting to sequential standard form are performed, the composite operation value of the task KPI concerned is stored and remains unchanged. This is discussed below.

Generally, when a semi-ring R exists, + indicates an additive operation of R, × indicates a multiplicative operation of R, a result of calculation on any elements a, b, and c in R is stored before and after the rewriting to additive standard form below and remains unchanged. This is because, for any members a, b, and cεR in the semi-ring R, the expressions below are guaranteed as an axiom, that is, a condition for that R is the semi-ring.

(a+b)×c→a×c+b×c

c×(a+b)→c×a+c×b

As previously described, in an embodiment of the present invention, a set of possible values for a task KPI is a semi-ring. When the task KPI has an additive operation as sequential composition and a multiplicative operation as parallel composition based on the KPI classification table 120, because the rewriting to sequential standard form is considered to be rewriting to additive standard form in the semi-ring, the composite operation value before and after the rewriting is stored and remains unchanged from the fact that the task KPI is the semi-ring. In contrast, when the task KPI has an additive operation as parallel composition and a multiplicative operation as sequential composition, the rewriting to parallel standard form is the same as the rewriting to additive standard form in the semi-ring, and the composite operation value before and after the rewriting is stored and remains unchanged.

The above is described below using the task KPI “maximum processing time” as an example. In an embodiment of the present invention, for example, the task KPI of “maximum processing time” is defined in the KPI classification table 120 such that the operation to the sequential composition (;) is “+” and the operation to the parallel composition (∥) is “Max.” This means that “maximum time” is a semi-ring in which the operation (Max) to the parallel composition is addition and the operation (+) to the sequential composition is multiplication. Accordingly, in this semi-ring, a result of calculation before and after rewriting for any elapsed times t1, t2, and t3 is stored and remains unchanged.

Max(t1,t2)+t3→Max((t1+t3),(t2+t3))

t3+Max(t1,t2)→Max((t3+t1),(t3+t2))

In this example, because the operation to the parallel composition is additive operation in the semi-ring, rewriting to parallel standard form has the same meaning as in the above-described rewriting. Accordingly, in the case of an example of the task KPI of “maximum processing time,” it is understood that, when rewriting to parallel standard form is performed, a result of calculation of composite operation is stored and remains changed.

Referring back to the description of FIG. 1, the rewriting scheme identifying unit 125 in an embodiment of the present invention identifies the rewriting scheme to be applied to eliminate the semi-ring structure contained in a business process that is a target for determining a calculation expression for a process KPI on the basis of the KPI classification table 120.

The graph structure rewriting unit 130 in an embodiment of the present invention identifies the semi-ring structure of a business process stored in the process definition storing unit 110. If it exists, the graph structure rewriting unit 130 rewrites the identified semi-ring structure by the rewriting scheme determined by the rewriting scheme identifying unit 125. The relation of connection of a plurality of tasks contained in the graph structure of a business process in an embodiment of the present invention includes sequential composition, parallel composition, and branch as a result of being rewritten by the graph structure rewriting unit 130.

The composite operation expression determining unit 135 in an embodiment of the present invention performs composite operation on a task KPI by referring to the KPI classification table 120 using the graph structure of the business process rewritten to one including sequential composition, parallel composition, and branch and further determines a calculation expression for finding the process KPI of the business process. At this time, when it is determined that conversion of KPIs between task KPIs is needed, the conversion is conducted using the conversion function table 140, which is described below.

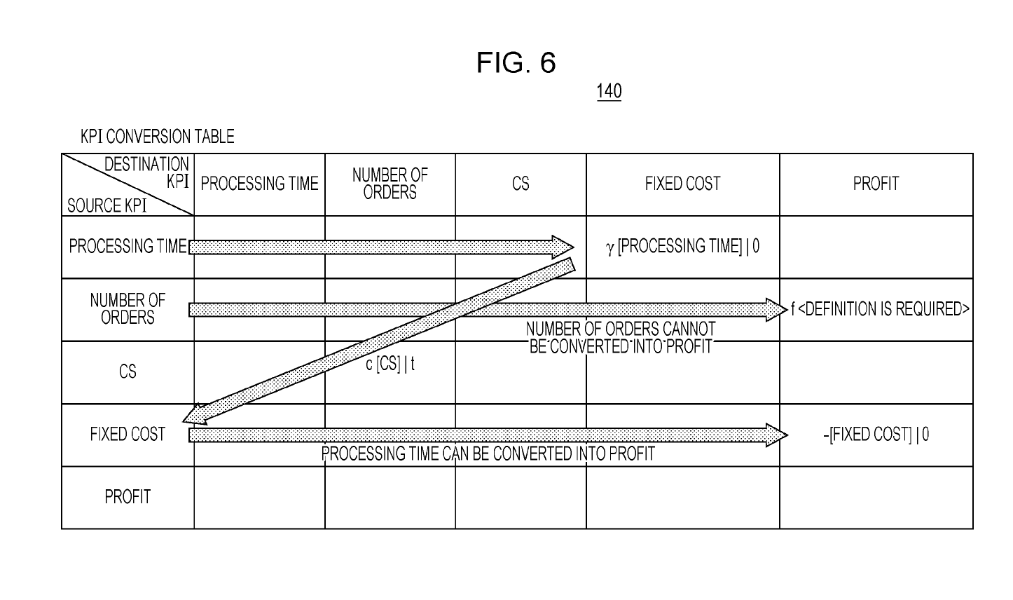

The conversion function table 140 in an embodiment of the present invention is a table that defines conversion functions between task KPIs and that is to be referred to in order to determine a calculation expression for a process KPI of a business process. FIG. 6 is an illustration for describing an example of a KPI conversion table according to an embodiment of the present invention. In an embodiment of the present invention, conversion functions between the five KPIs of “processing time,” “number of orders,” “customer satisfaction (CS),” “cost,” and “profit” can be defined in the KPI conversion table in FIG. 6. In an embodiment of the present invention, for example, the following conversion function is used in conversion from processing time to cost.

Cost=γ[Processing Time]|0

In an embodiment of the present invention, the following conversion function is used in conversion from cost to profit.

Profit=−[Cost]|0

Because a conversion function for use in conversion from “number of orders” to “profit” is not defined in the conversion function table 140, which is illustrated in FIG. 6 and is an illustrative example in an embodiment of the present invention, “number of orders” cannot be converted to “profit.” Accordingly, it is necessary to define a corresponding conversion function through the conversion function defining prompt 145, which is described below.

When the composite operation expression determining unit 135 detects that a necessary conversion function is not registered in the conversion function table 140, the conversion function defining prompt 145 in an embodiment of the present invention prompts a user or an administrator to enter the necessary conversion function through the input and output unit 105 in response to an instruction from the composite operation expression determining unit 135. The conversion function defining prompt 145 in an embodiment of the present invention registers the entered conversion function in the conversion function table 140.

The KPI calculation expression storing unit 150 in an embodiment of the present invention stores a calculation expression for finding a process KPI of a business process determined by the composite operation expression determining unit 135. As previously described, the calculation expressions stored in the KPI calculation expression storing unit 150 are shown to a user through the input and output unit 105.

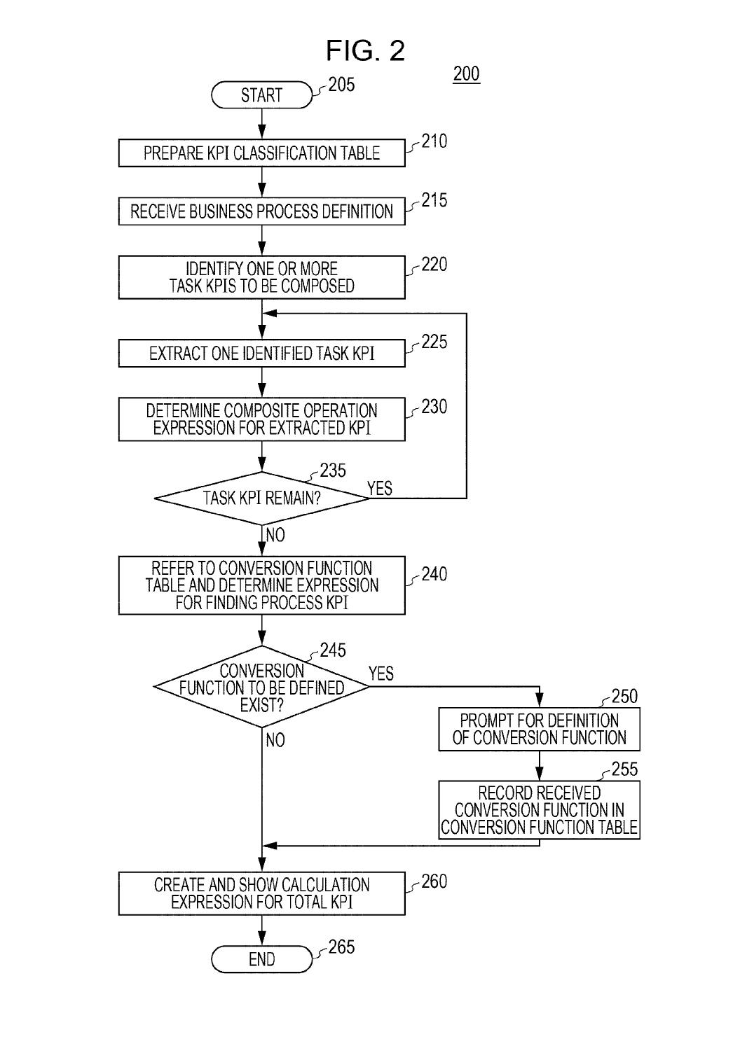

FIG. 2 is a flowchart 200 illustrating a whole operation in the KPI calculation system according to an embodiment of the present invention. The processing begins at block 205 and prepares the KPI classification table 120 at block 210. The KPI classification table 120 is prepared by a user or an administrator from scratch or by modifying in part a KPI classification table used in the past. The KPI classification table 120 is described above, so the detailed description is not repeated here.

Then the processing proceeds to block 215 and receives a graph structure of a business process definition that is a target of determining a calculation expression for a process KPI. The business process definition in an embodiment of the present invention is a graph structure that includes nodes corresponding to a plurality of tasks and edges connecting the nodes and representing how the processing of the tasks proceeds, as previously described with reference to FIGS. 7 and 8.

The graph structure can be entered in various forms and can be stored in the system in accordance with a predetermined format. For example, data on a business process that has been generated in an external business process management system (not illustrated) connected to the KPI calculation system in an embodiment of the present invention may be imported through the input and output unit 105 and may be stored in the process definition storing unit 110 in a predetermined format. A user or an administrator may enter a business process definition through the input and output unit 105 without using another system.

The business process definition stored in the process definition storing unit 110 in an embodiment of the present invention contains a calculation expression that indicates how a process KPI is to be found from the sum obtained by composite operation of task KPIs over the business process. In an embodiment of the present invention, such a calculation expression is entered by a user through the input and output unit 105.

The processing proceeds to block 220 and identifies one or more types of task KPIs required to be subjected to composite operation to find the process KPI of the business process definition received at block 215. In an embodiment of the present invention, the types of task KPIs required are identified by analyzing the calculation expression, which is included in the target business process definition and indicates how the process KPI is to be found from the sum obtained by composite operation of the task KPIs performed over the business process. It is to be understood that, in the case of one example illustrated in FIG. 13, the types of task KPIs to be subjected to composite operation are “maximum processing time” and “(fixed) cost.”

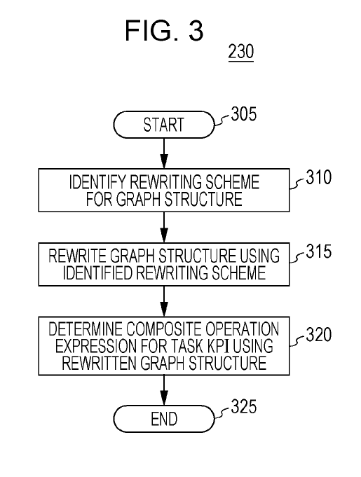

Then at block 225, one of the one or more types of task KPIs identified at block 220 is extracted. The processing further proceeds to block 230 and determines the task KPI composite operation expression for the type of the task KPI extracted at block 225. Such determination of the task KPI composite operation expression is described in detail below with reference to FIG. 3.

FIG. 3 is a flowchart that illustrates a specified operation for determining a KPI calculation expression in the KPI calculation system according to an embodiment of the present invention. The processing begins at block 305 and identifies the rewriting scheme for the graph structure at block 310 by referring to the KPI classification table 120. It is to be noted that the rewriting scheme for the graph structure can vary depending on the type of the task KPI extracted at block 225.

At block 310, for example, when the type of the task KPI extracted at block 225 is “maximum processing time,” the KPI classification table 120 is referred to and the rewriting scheme of “rewriting to parallel standard form” is identified. When the type of the task KPI extracted at block 225 is “number of maximum concurrently operating people,” the KPI classification table 120 is referred to and the rewriting scheme of “rewriting to sequential standard form” is applied. When the type of the task KPI proceeds to block 225 is “cost,” the KPI classification table 120 is referred to and the rewriting scheme of “rewriting to parallel standard form and evaluating each task only once” is applied.

Then the processing proceeds to block 315 and rewrites the graph structure of the business process using the rewriting scheme identified at block 310.

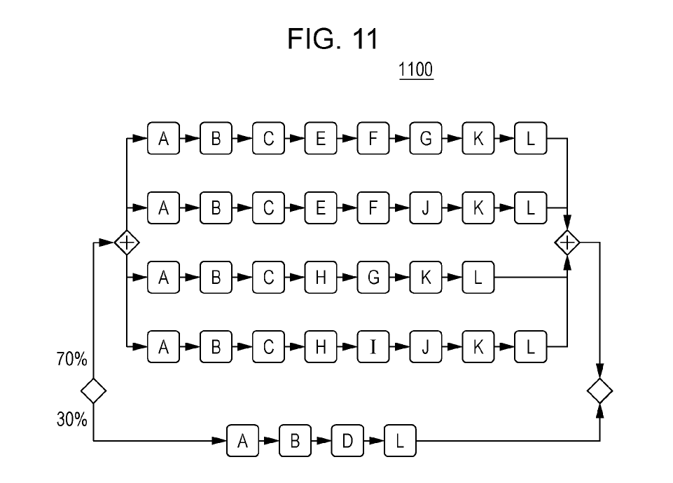

Here, when the type of the task KPI extracted at block 225 is “maximum processing time,” because the rewriting scheme of “rewriting to parallel standard form” is identified at block 310, the graph structure is rewritten using any of the following conversion expressions, which are previously described, and a graph structure 1100 illustrated in FIG. 11 is finally obtained.

(P∥Q);R→(P;R)∥(Q;R) (A)

R;(P∥Q)→(R;P)∥(R;Q) (B)

R∥(P∥Q)→(R∥P∥Q) (C)

P∥Q→Q∥P (D)

where P, Q, and R indicate tasks contained in a business process.

The graph structure 1100 illustrated in FIG. 11 is equivalent to the following algebraic expression:

((A;B;C;E;F;G;K;L)∥(A;B;C;E;F;J;K;L)∥(A;B;C;H;G;K;L)∥(A;B;C;H;I;J;K;L))0.7v0.3(A;B;D;L)

As indicated in the KPI classification table 120, for “maximum processing time,” “∥” is replaced with “Max,” and “;” is replaced with “+.” Accordingly, the composite operation expression for the task KPI of “maximum processing time” is as follows:

The composite operation value of maximum processing time=0.7*Max((MT[A]+MT[B]+MT[C]+MT[E]+MT[F]+MT[G]+MT[K]+MT[L]),(MT[A]+MT[B]+MT[C]+MT[E]+MT[F]+MT[J]+MT[K]+MT[L]),(MT[A]+MT[B]+MT[C]+MT[H]+MT[G]+MT[K]+MT[L]),(MT[A]+MT[B]+MT[C]+MT[H]+MT[I]+MT[J]+MT[K]+MT[L])+0.3*(MT[A]+MT[B]+MT[D]+MT[L])

where MT[X] indicates a task KPI value of a task X for maximum processing time.

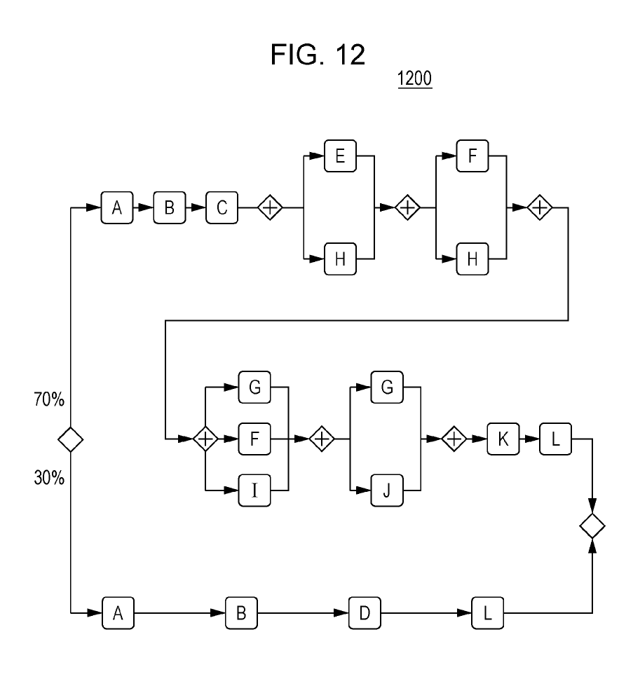

When the type of the task KPI extracted at block 225 is “fixed cost,” because the rewriting scheme of “rewriting to sequential standard form” is identified at block 310, the graph structure is rewritten using the following conversion expressions, which are previously described, and a graph structure 1200 illustrated in FIG. 12 is finally obtained.

(P;Q)∥R→(P∥R);(Q∥R), and

R∥(P;Q)→(R∥P);(R∥Q)

R∥(P∥Q)→(R∥P∥Q)

P∥Q→Q∥P

where P, Q, and R indicate tasks contained in a business process.

The graph structure 1200 illustrated in FIG. 12 is equivalent to the following algebraic expression:

((A;B;C;(E∥H);(F∥H);(G∥F∥I);(G∥J);K;L))0.7V0.3(A;B;D;L)

In an embodiment of the present invention, as is understood from the KPI classification table 120, when the task KPI is “fixed cost,” to make a set whose addition and multiplication are “+” be also a semi-ring, “evaluating each task only once” is to be conducted. To this end, each of the tasks in the sections on both sides of “V” in the above-described algebraic expression is evaluated only once, and one that has not been evaluated is changed into a zero element. As indicated in the KPI classification table 120, for “fixed cost,” “∥” is replaced with “+,” and “;” is replaced with “+.” Accordingly, the composite operation expression for the task KPI of “fixed cost” is as follows:

The composite operation value of fixed cost=0.7*(FC[A]+FC[B]+FC[C]+FC[E]+FC[H]+FC[F]+FC[G]+FC[I]+FC[J]+FC[K]+FC[L])+0.3*(FC[A]+FC[B]+FC[C]+FC[D])

where FC[X] indicates a task KPI value of a task X for fixed cost.

Then the processing proceeds to block 320 and determines the composite operation expression for the task KPI using the rewritten graph structure. The processing proceeds to block 325 and ends.

The description returns to the flowchart in FIG. 2. At block 235, it is determined whether there remains a task KPI that has been identified at block 220 but not been extracted at block 225. When it is determined that there remains such a task KPI at block 235, the processing proceeds from the arrow YES to block 225, and blocks 225 to 235 are repeated. When it is determined that there remains no task KPI at block 235, the processing proceeds from the arrow NO to block 240.

At block 240, the calculation expression for the process KPI is determined using the composite operation expression for the task KPI determined at block 230. To determine this calculation expression for the process KPI, the conversion function table 140 is referred to in order to perform conversion between the KPIs.

The processing proceeds to block 245 and determines whether there exists a conversion function to be additionally defined in the conversion function table 140 to determine the calculation expression for the process KPI. When it is determined that there exists such a conversion function to be additionally defined at block 245, the processing proceeds from the arrow YES to block 250, and a user and/or an administrator is prompted to enter definition of the conversion function. The processing proceeds to block 255, registers the conversion function entered by the user or the administrator as a result of the prompting in the conversion function table, and proceeds to block 260.

When it is determined that there exists no conversion function to be additionally defined at block 245, the processing proceeds from the arrow NO to block 260. At block 260, the calculation expression for the total KPI (KPI tree) is created, stored, and shown to a user, an administrator, or another system. The processing proceeds to block 265 and ends.

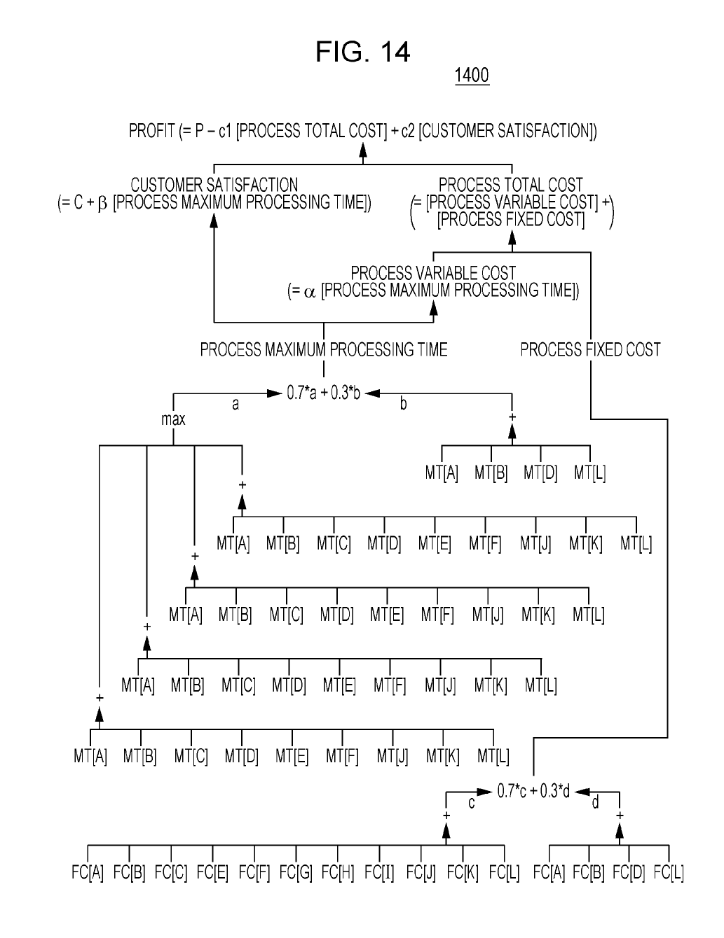

FIG. 14 illustrates an example of a KPI tree broken down to a task KPI level according to an embodiment of the present invention. It is to be noted that this KPI tree represents a calculation expression for finding “profit” that is a process KPI to the business process illustrated in FIG. 7.

FIG. 15 illustrates an example of a hardware configuration of an information processing apparatus suitable for achieving the KPI calculation system according to an embodiment of the present invention. The information processing apparatus includes the central processing unit (CPU) 1 and the main memory 4, which are connected to a bus 2. The bus 2 is also connected to removal storages (external storage systems whose recoding media are exchangeable), such as hard disk devices 13 and 30, compact-disk read-only memory (CD-ROM) devices 26 and 29, a flexible disk device 20, a magneto-optical (MO) device 28, and a digital versatile disc (DVD) device 31, through a flexible disk controller 19, an integrated drive electronics (IDE) controller 25, a small computer system interface (SCSI) controller 27, and the like.

Storage media, such as a flexible disk, an MO, a CD-ROM, and a DVD-ROM, are inserted into the removal storages. Code of a computer program for carrying out the present invention and for providing the CPU and the like in cooperation with the operating system with an instruction can be recorded in these storage media, the hard disk devices 13 and 30, and a ROM 14. The computer program is executed by being loaded into the main memory 4. The computer program can be compressed or divided into a plurality of portions and can be recorded on a plurality of media.

The information processing apparatus receives an input from an input device, such as a keyboard 6 or a mouse 7, through a keyboard/mouse controller 5. The information processing apparatus is connected to a display device 11 for presenting visual data to a user through a DAC/LCDC 10.

The information processing apparatus can be connected to a network through a network adapter 18 (e.g., Ethernet®) and can communicate with another computer and the like. Although not illustrated, the information processing apparatus can be connected to a printer through a parallel port and can be connected to a modem through a serial port.

From the above description, it will be readily understood that the information processing apparatus suitable for achieving the KPI calculation system according to an embodiment of the present invention can be achieved by a typical information processing apparatus such as a personal computer, a workstation, or a mainframe or a combination thereof. These components are illustrated by example, and not all of the components are necessary as the indispensable components to the present invention.

A person skilled in the art can easily conceive of various modifications, such as implementing the hardware components of the information processing apparatus used in an embodiment of the present invention by combining a plurality of machines and distributing their functions to the machines. These modifications are a concept naturally included in the idea of the present invention.

The KPI calculation system in an embodiment of the present invention can adopt an operating system that supports a graphical user interface (GUI) multi-window environment, such as the Windows® operating system provided by Microsoft Corporation, the Mac OS® provided by Apple Inc., and a UNIX® system (for example, AIX® provided by International Business Machines Corporation).

From the above, it can be understood that the KPI calculation system used in an embodiment of the present invention is not limited to a specific operating system environment.

The present invention can be achieved as a system, a method, or a computer program product, as is understood by a person skilled in the art. Thus the present invention can take the form of an entirely hardware embodiment, an entirely software embodiment (including firmware, resident software, microcode, and the like), or an embodiment in which software and hardware are combined, which is generally called “circuit,” “module,” or “system.” Furthermore, the present invention can also take the form of a computer program product achieved by a tangible representation medium having program code usable by a computer achieved by the medium.

The present invention can also use a combination of computer-usable/computer-readable media. Examples of each of the computer-usable/computer-readable media can include, but are not limited to, an electronic, magnetic, optical, electromagnetic, infrared, or semiconductor system, apparatus, device, or propagation medium. More specific examples (a non-exhaustive list) of the computer-readable medium includes the following: an electrical connection having one or more leading wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a transmission medium such as one supporting the Internet or an intranet, and a magnetic storage device.

It is to be noted that the computer-usable/computer-readable medium may be paper or another suitable medium on which the program is printed, because the program can be electronically captured by optical scanning performed on the paper or other medium, then compiled, interpreted, or otherwise processed in a suitable manner, if necessary, and then stored in a computer memory. The computer-usable/computer-readable medium may be any medium that can contain, store, communicate with, propagate, or transport the program for use by or in connection with an instruction execution system, apparatus, or device. The computer-usable medium may include a propagated data signal that includes program code that can be used by a computer achieved together as in baseband or as part of a carrier wave. The computer-usable program code may be transmitted using any appropriate medium, including but not limited to a wireless medium, a wire line, an optical fiber cable, an RF, and the like.

Computer program code for carrying out the present invention can be written using one of or a combination of a plurality of programming languages, including an object-oriented programming language, such as Java, Smalltalk, C++, or the like, and a traditional procedural programming language, such as the C program language or similar programming languages. The program code can be executed entirely on a computer of a user, partly on the computer of the user, as an independent software package, partly on the computer of the user and partly on a remote computer, or entirely on the remote computer or on a server. In the latter scenario, the remote computer can be connected to the computer of the user through any type of network, including a local area network (LAN) or a wide area network (WAN). Alternatively, the connection can be made on an external computer (over, for example, the Internet using an internet service provider).

An embodiment of the present invention is described above with reference to the illustrations of the flowcharts and/or the block diagrams for a method, an apparatus (system), and a computer program product. It will be understood that each block in the illustrations of the flowcharts and/or the block diagrams, and combinations of blocks in the illustrations of the flowcharts and/or the block diagrams can be implemented by instructions of the computer program. These instructions of the computer program can be provided to a processor of a general purpose computer, a special purpose computer, or other programmable data processing apparatus to produce a machine such that the instructions, which are executed through the processor of the computer or other data processing apparatus, create means for performing a function/action specified in one or more blocks in the flowcharts and/or the block diagrams.

These instructions of the computer program can also be stored in a computer-readable medium that can be made to function in a specific form such that an instruction stored in a computer-readable medium produces a product including instruction means for performing a function/action specified in one or more blocks in the flowcharts and/or the block diagrams.

The instructions of the computer program can also be loaded onto a computer or other programmable data processing apparatus to cause a series of operations to be performed on the computer or other programmable apparatus to produce a computer-implemented process such that the instructions which are executed on the computer or other programmable apparatus provide processes for performing a function/action specified in one or more blocks in the flowcharts and/or the block diagrams.

The flowcharts and the block diagrams in the drawings illustrate architectures, functionality, and executing actions of a system, a method, and a computer program product in various embodiments in this invention. In this respect, each block in the flowcharts or the block diagrams can indicate a module, a segment, or a code portion including one or more executable instructions for performing a specified logical function. It is to be noted that in a certain alternative implementing example the functions indicated by the blocks may be performed in order different from that illustrated in the drawings. For example, depending on the related functionality, two blocks illustrated in sequence may be performed at substantially the same time, or may be performed in inverse order. Each block in the block diagrams and/or the illustrations of the flowcharts and combinations of the blocks in the block diagrams and/or the illustrations of the flowcharts can be achieved by a special-purpose hardware-based system for performing a special function or action or a combination of pieces of special-purpose hardware.

It is obvious to a person skilled in the art that various modifications or improvements can be added to the above-described embodiment. For example, an embodiment of the present invention assumes that business process definitions in a single format exist in a system. Business process definitions in different formats may coexist. If needed, processing may be performed while a business process definition in a certain format is converted into another format.

It is understood that according to an embodiment of the present invention a calculation expression for finding a process KPI of a business process from task KPIs can be automatically created.

1. A computer-implemented method for determining a calculation expression for finding a KPI relating to a business process (process KPI) on the basis of a KPI obtained in each task (task KPI), the business process being representable as a graph structure including a plurality of tasks and edges representing how processing of the tasks proceeds, the method comprising:
preparing a table defining a group of composite operation expressions for the task KPIs of the plurality of tasks, the composite operation expressions being associated with a predetermined relation of the plurality of tasks for each task KPI type;
determining composite operation expressions for the task KPIs over the business process for each task KPI type by referring to the table; and
creating a calculation expression for finding the process KPI of the business process using the composite operation expressions for the task KPIs over the business process.

2. The method according to claim 1, wherein the determining includes:
identifying a predetermined rewriting scheme for the graph structure with respect to the group of composite operation expressions corresponding to the task KPIs for the type of a certain task KPI, the rewriting scheme defining a scheme for converting a graph structure including a portion being impossible to be subjected to composite operation using the group of composite operation expressions into a graph structure including such a portion;
rewriting the graph structure of the business process using the identified rewriting scheme; and
determining the composite operation expressions for the task KPIs over the business process for the type of the certain task KPI by referring to the table

3. The method according to claim 2, wherein the rewriting scheme includes a scheme for rewriting the graph structure of a given business process to parallel standard form.

4. The method according to claim 3, wherein the scheme for rewriting the graph structure of the given business process to parallel standard form is implemented by repeating rewriting of the graph structure using at least one of the following calculation expressions:
(P∥Q);R→(P;R)∥(Q;R)
R;(P∥Q)→(R;P)∥(R;Q)
R∥(P∥Q)→(R∥P∥Q)
P∥Q→Q∥P
where P, Q, and R indicate tasks contained in the given business process.

5. The method according to claim 2, wherein the rewriting scheme includes a scheme for rewriting the graph structure of a given business process to sequential standard form.

6. The method according to claim 5, wherein the scheme for rewriting the graph structure of the given business process to sequential standard form is implemented by repeating rewriting of the graph structure using at least one of the following calculation expressions:
(P;Q)∥R→(P∥R);(Q∥R)
R∥(P;Q)→(R∥P);(R∥Q)
R∥(P∥Q)→(R∥P∥Q)
P∥Q→Q∥P
where P, Q, and R indicate tasks contained in the given business process.

7. The method according to claim 1, wherein the predetermined relation of the plurality of tasks includes at least one of parallel composition, sequential composition, and branch.

8. The method according to claim 1, further comprising a step of determining the calculation expression for determining the process KPI using a conversion function between provided task KPIs.

9. The method according to claim 8, wherein the conversion function is a time-dependent function.

10. The method according to claim 8, further comprising a step of prompting for entry of a conversion function to be defined, in response to detection of presence of the conversion function to be defined.

11. The method according to claim 1, wherein a set of possible values for the task KPI is a semi-ring.

12. The method according to claim 1, further comprising a step of receiving a business process definition including a plurality of tasks and edges representing how processing of the tasks proceeds.

13. The method according to claim 1, further comprising a step of identifying a type of a task KPI necessary to find the process KPI of the business process.

14. A program product for causing a computer to perform the method according to claim 1.

15. A system including means for performing the method according to claim 1.

16. A system for determining a calculation expression for finding a KPI relating to an entire business process (process KPI) on the basis of a KPI obtained in each task (task KPI), the business process being representable as a graph structure including a plurality of tasks and edges representing how processing of the tasks proceeds, the system comprising:
a table defining a group of composite operation expressions for the task KPIs of the plurality of tasks, the composite operation expressions being associated with a predetermined relation of the plurality of tasks for each task KPI type;
a determining unit configured to determine composite operation expressions for the task KPIs over the business process for each task KPI type by referring to the table; and
a creating unit configured to create a calculation expression for finding the process KPI of the business process using the composite operation expressions for the task KPIs over the business process.
